(19) United States
(12) Patent Application Publication
(10) Pub. No.: US 2024/0083183 A1
(43) Pub. Date: Mar. 14, 2024

(54) RECORDING APPARATUS AND LUBRICANT APPLICATION METHOD

(71) Applicant: CANON KABUSHIKI KAISHA, Tokyo (JP)

(72) Inventors: YUSUKE NARATANI, Tokyo (JP); ATSUSHI KOHNOTOH, Tokyo (JP); KEN TAKENAGA, Kanagawa (JP); TAKASHI ABE, Kanagawa (JP); KOUSUKE TANAKA, Kanagawa (JP)

(21) Appl. No.: 18/459,632

(22) Filed: Sep. 1, 2023

(30) Foreign Application Priority Data
Sep. 9, 2022 (JP) 2022-144041

(51) Int. Cl. B41J 25/00

(52) U.S. Cl. CPC B41J 25/001

(57) ABSTRACT

A recording apparatus includes: a carriage on which a liquid ejection head that ejects a liquid is mounted, the carriage being reciprocally movable in a scanning direction; a guide member that extends in the scanning direction and that guides movement of the carriage in the scanning direction; and a sliding member that is provided on the carriage and has a sliding surface that slides with a guide surface of the guide member via a lubricant, in a case where the carriage moves in the scanning direction. The carriage has a projecting portion that projects farther toward one side in the scanning direction than the sliding member. A gap formed between the projecting portion and the guide surface becomes smaller toward the sliding member in the scanning direction.

### BACKGROUND OF THE INVENTION

### Field of the Invention

The present invention relates to an inkjet recording apparatus that ejects ink to form an image on a recording medium.

### Description of the Related Art

An inkjet recording apparatus is composed of a recording head that ejects ink to a recording medium, a carriage on which the recording head is mounted, and a guide member that guides movement of the carriage in a direction (hereinafter also referred to as a “main scanning direction”) that intersects the conveying direction (hereinafter also referred to as a “sub scanning direction”) of the recording medium. The carriage is provided with sliding members that have sliding surfaces in contact with a guide surface of the guide member via a lubricant, the sliding members being arranged in the extension direction (main scanning direction) of the guide surface.

To spread the lubricant between the guide surface of the guide member and the plurality of sliding surfaces of the sliding members during product assembly, the lubricant is applied to one side of the guide surface in the main scanning direction with respect to the carriage. Then, the lubricant is spread between the guide surface and the plurality of sliding surfaces by repeatedly performing reciprocal movement, in which the carriage is moved to the one side of the guide surface in the main scanning direction where the lubricant is applied and thereafter moved to the other side in the main scanning direction opposite to the one side.

At this time, when the carriage is first moved to the one side of the guide surface in the main scanning direction, the lubricant may not be able to enter a space between the sliding surface of the sliding member that first contacts the lubricant and the guide surface, and this causes an extra lubricant. This extra lubricant may be wasted, since this lubricant contacts a side surface of the sliding member on the one side in the main scanning direction and then is pushed out by an end of the guide surface and cannot be returned.

Japanese Patent Application Publication No. 2016-135616 describes a recording apparatus that addresses such an issue. In the recording apparatus described in Japanese Patent Application Publication No. 2016-135616, a plurality of grooves are formed in sliding surfaces of sliding members provided on both sides of a carriage in the main scanning direction, the grooves extending along the conveying direction to hold a lubricant applied to a guide surface, allowing the lubricant to be efficiently spread between the sliding surfaces of the sliding members and the guide surface.

### SUMMARY OF THE INVENTION

In the recording apparatus described in Japanese Patent Application Publication No. 2016-135616, however, the grooves are formed in the sliding surfaces of the sliding members, and therefore a higher surface pressure acts between the guide surface of the guide member and the sliding surfaces of the sliding members, which leads to wear of the sliding members. When the sliding members are worn, the posture of the carriage on which a recording head is mounted is affected to degrade the precision in printing onto a recording medium. In addition, the sliding surfaces are divided into a plurality of surfaces by forming the grooves, and therefore there may be a difference in height among the surfaces (necessity arises to provide a tolerance in height between a sliding surface A and a sliding surface B in the drawings). Thus, the contact between the guide surface of the guide member and the sliding surfaces of the sliding members may not be stable for some components. Also in this case, the printing precision may be degraded as when the sliding members are worn.

Thus, the present invention has been made in view of the above issue, and therefore has an object to provide a recording apparatus capable of efficiently spreading a lubricant between sliding surfaces of sliding members and a guide surface.

In order to achieve the above object, the present invention provides a recording apparatus including:
a carriage on which a liquid ejection head that ejects a liquid is mounted, the carriage being reciprocally movable in a scanning direction;
a guide member that extends in the scanning direction and that guides movement of the carriage in the scanning direction; and
a sliding member that is provided on the carriage and has a sliding surface that slides with a guide surface of the guide member via a lubricant, in a case where the carriage moves in the scanning direction, wherein:
the carriage has a projecting portion that projects farther toward one side in the scanning direction than the sliding member; and
a gap formed between the projecting portion and the guide surface becomes smaller toward the sliding member in the scanning direction.

In order to achieve the above object, in addition, the present invention provides a method of applying a lubricant to the sliding surface of the sliding member of the recording apparatus described above, the method including:
a first moving step of moving the carriage toward one side of the guide member in the scanning direction;
a contact step of bringing the lubricant on the guide surface into contact with the projecting portion, after the first moving step;
an application step of applying the lubricant, which has been brought into contact with the projecting portion, to the sliding surface, after the contact step; and
a second moving step of reciprocally moving the carriage in the scanning direction, after the application step.

With the present invention, it is possible to efficiently spread a lubricant between sliding surfaces of sliding members and a guide surface.

Further features of the present invention will become apparent from the following description of exemplary embodiments with reference to the attached drawings.

### BRIEF DESCRIPTION OF THE DRAWINGS

FIG. 1 is a perspective view of a recording apparatus according to a first embodiment of the present invention;

FIG. 2 is a perspective view of a carriage unit according to the first embodiment of the present invention;

FIG. 3 is a sectional view of the carriage unit according to the first embodiment of the present invention;

FIG. 4 is a sectional view of an area (lower part of the carriage unit) around a sliding member according to the first embodiment;

FIG. 5 is a sectional view of an area (upper part of the carriage unit) around a sliding member according to the first embodiment;

FIG. 6 is an enlarged view of an area around the sliding member according to the first embodiment;

FIG. 7 is a side view of a carriage according to the first embodiment of the present invention;

FIG. 8 is a sectional view of the carriage according to the first embodiment of the present invention;

FIG. 9 is a sectional view of an area around the sliding member according to the first embodiment of the present invention;

FIG. 10 is an enlarged view of an area around the sliding member according to the first embodiment of the present invention;

FIGS. 11A and 11B are each a schematic view illustrating how a lubricant is spread according to the first embodiment of the present invention;

FIG. 12 is a schematic view of an area around a sliding member according to a second embodiment of the present invention;

FIG. 13 is a back view of a carriage according to a third embodiment of the present invention;

FIG. 14 is a sectional view of an area around a sliding member according to the third embodiment of the present invention;

FIG. 15 is a perspective view of a carriage unit according to the third embodiment of the present invention; and

FIG. 16 is a schematic view of an area around a sliding member according to a fourth embodiment of the present invention.

### DESCRIPTION OF THE EMBODIMENTS

A mode for carrying out the invention will be described in detail below by way of example on the basis of embodiments with reference to the drawings. The dimensions, materials, shapes, relative arrangement, etc. of constituent components described in the embodiments should be changed, as appropriate, in accordance with the configuration of an apparatus to which the invention is applied and under various conditions. In addition, all combinations of features described in the embodiments are not always essential to the solution of the present invention. The constituent elements described in the embodiments are merely exemplary, and it is not intended that the scope of the invention should be limited to such constituent elements.

### First Embodiment

### Inkjet Recording Apparatus

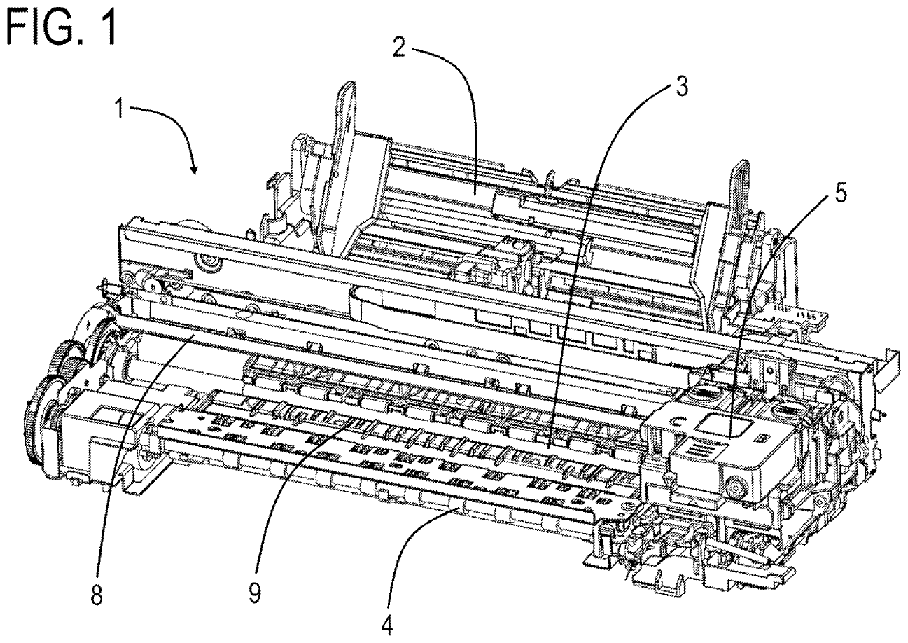

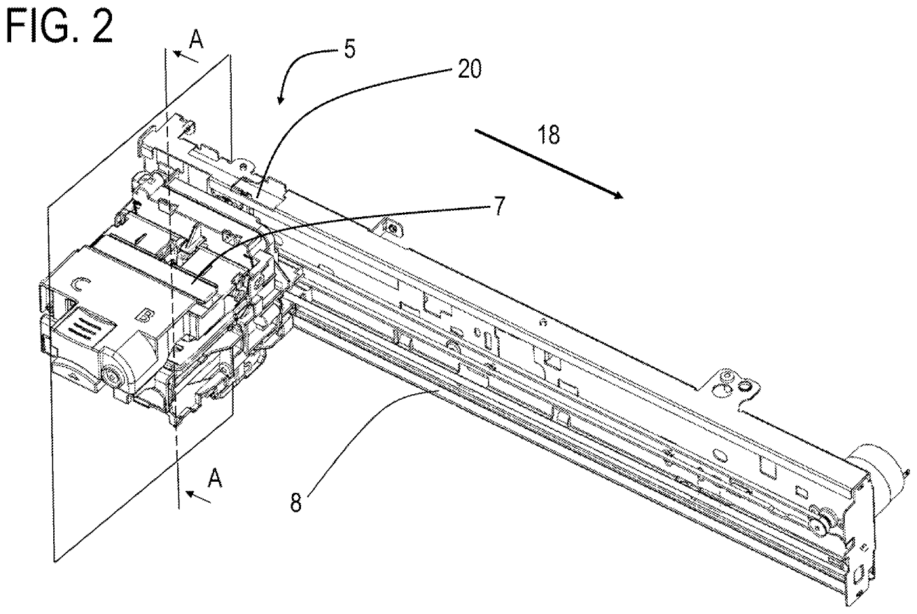

FIG. 1 is a perspective view of a recording apparatus to which the present invention is applicable. A recording apparatus 1 includes a supply feed mechanism 2, a conveying portion 3, a discharge feed portion 4, and a carriage unit 5. FIG. 2 is a perspective view of a carriage unit. The carriage unit 5 includes a carriage 7 on which a recording head 6 is mounted, and a guide member 8 that guides movement of the carriage 7 in a main scanning direction that is orthogonal to the conveying direction of a recording medium. Recording is performed on the recording medium by reciprocally moving the carriage 7 in the main scanning direction and ejecting liquid ink toward the recording medium from the recording head 6 as a liquid ejection head.

The recording medium is loaded in the supply feed mechanism 2. The recording medium is conveyed to a position facing the recording head 6 by way of the conveying portion 3. The recording medium on which recording has been performed is discharged to the outside of the recording apparatus 1 by way of the discharge feed portion 4. The recording apparatus 1 is also provided with a platen 9 that faces a surface (hereinafter referred to as an “ejection surface”) of the recording head 6 from which a liquid is ejected. The platen 9 is provided to support the recording medium during recording operation. The ejection surface of the recording head 6 directly faces the recording medium supported by the platen 9 with an appropriate clearance kept therebetween.

Carriage Unit

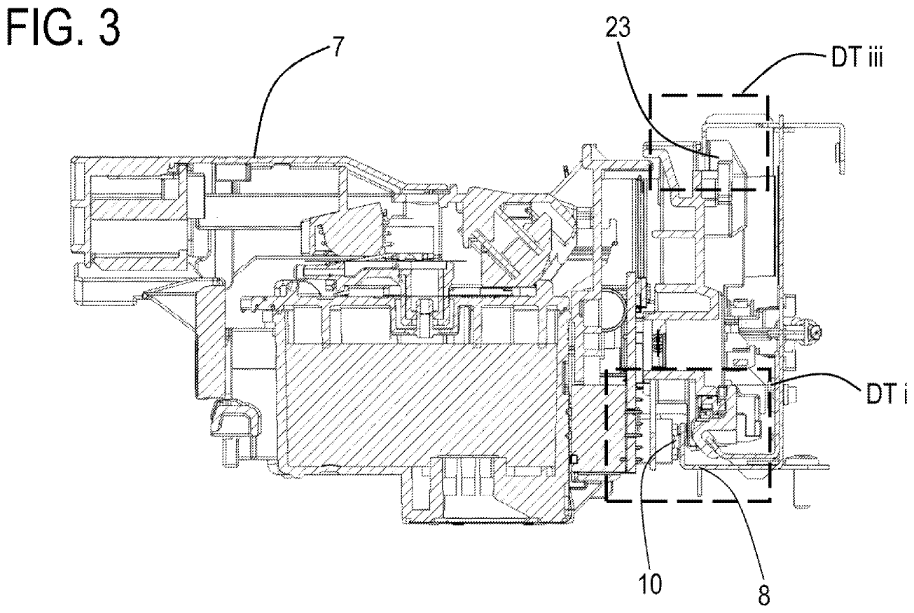

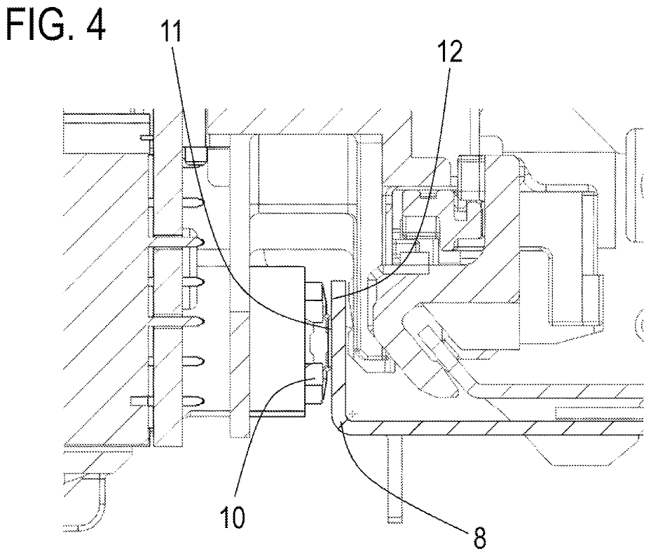

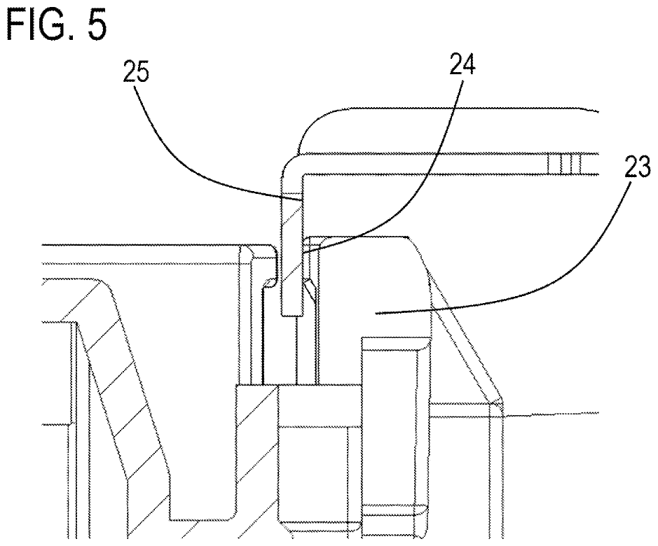

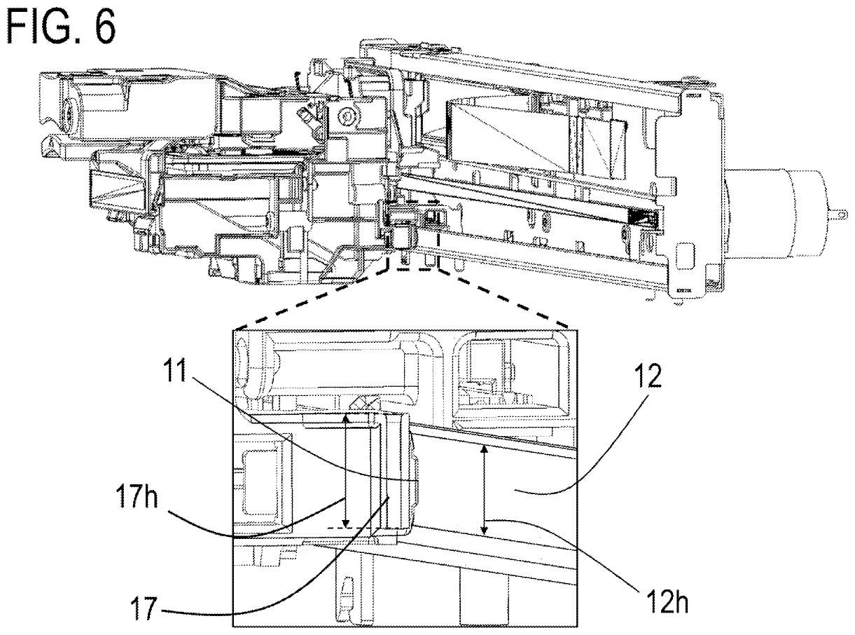

FIG. 3 is a sectional view of the carriage unit 5, taken along the A-A section. FIG. 4 is an enlarged view of an area (DTi in FIG. 3) around a sliding member 10 in FIG. 3. FIG. 5 is an enlarged view of an area (DTiii in FIG. 3) around a sliding member 23 in FIG. 3. The carriage 7 includes a sliding member 10 constituted of a resin and provided at the lower part of the carriage 7, and a sliding member 23 constituted of a resin and provided at the upper part of the carriage 7. The sliding member 10 has a sliding surface 11. The sliding member 23 has a sliding surface 24. The guide member 8 is an elongated metal plate member that extends along the scanning direction of the carriage 7, and has a guide surface 12 that slides with the sliding member 10 and a guide surface 25 that slides with the sliding member 23. As illustrated in FIG. 6, the guide surface 12 has a sliding range with a low surface roughness and having a width 12h.

In order to support the weight of the carriage 7, the sliding surface 11 and the guide surface 12 face and contact each other at the lower part of the carriage 7, and the sliding surface 24 and the guide surface 25 face and contact each other at the upper part of the carriage 7. The sliding surface 11 and the guide surface 12 and the sliding surface 24 and the guide surface 25 slide with each other when the carriage 7 is moved in the main scanning direction for scanning. When the sliding surfaces 11 and 24 and the guide surfaces 12 and 25 slide with each other at this time, the sliding surface 11 and the sliding surface 24 which are resin members are worn against the guide member 8 which is a metal plate member. Therefore, a lubricant such as grease, for example, is interposed between the sliding surfaces 11 and 24 and the guide surfaces 12 and 25 to suppress wear of the sliding surfaces 11 and 24, enabling smooth sliding.

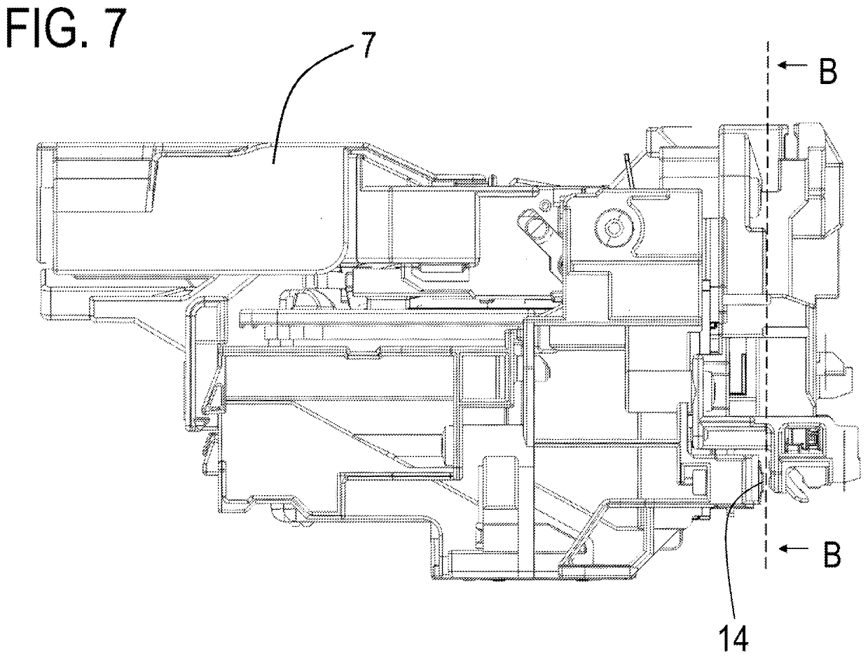

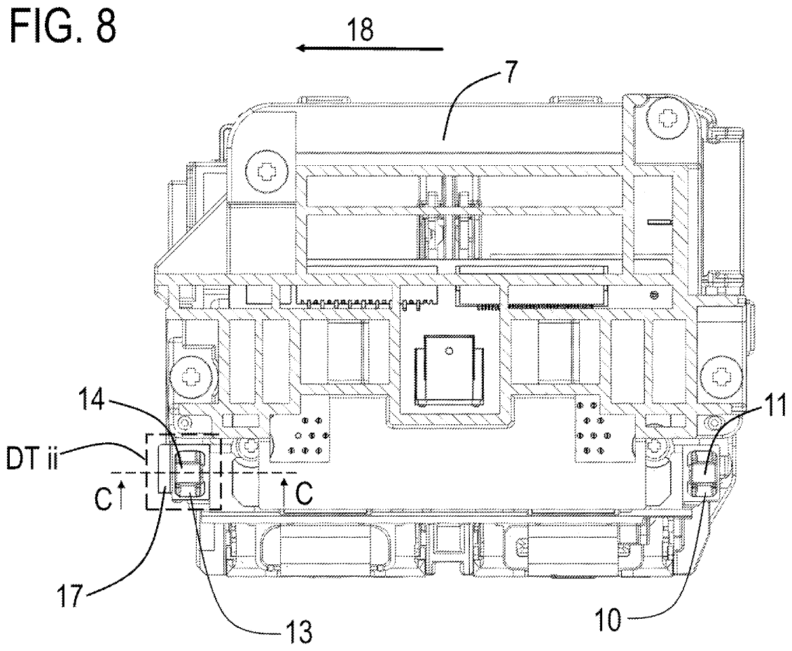

FIG. 7 is a side view of the carriage 7. FIG. 8 is a sectional view of the carriage 7 illustrated in FIG. 7, taken along the B-B section. The carriage 7 receives an inertial force in the rotational direction of an axis that is perpendicular to the ejection surface during scanning, and includes two sliding members 10 and 13 arranged in the scanning direction in order to suppress swing of the carriage 7 due to the inertial force. As with the sliding member 10, the sliding member 13 has a sliding surface 14 that faces and contacts the guide surface 12 via a lubricant. The sliding surface 14 and the guide surface 12 slide with each other when the carriage 7 performs scanning.

Assembly of Carriage to Guide Member

As illustrated in FIG. 2, a hole 20 is provided in a part of the upper surface of the guide member 8 in a region in which the carriage 7 is movable in the main scanning direction. The hole 20 enables the carriage 7 to be retracted upward. This enables the carriage 7 to be assembled to the guide member 8. Since the carriage 7 is assembled around the hole 20, the carriage 7 is moved in a direction 18 from an end portion of the guide member 8 on one side toward an end portion on the opposite side when the carriage 7 performs the first scanning after the assembly.

Spreading of Lubricant on Guide Surface

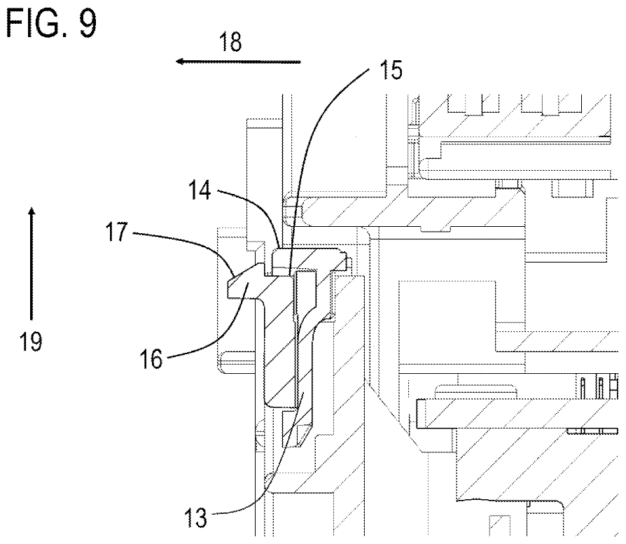

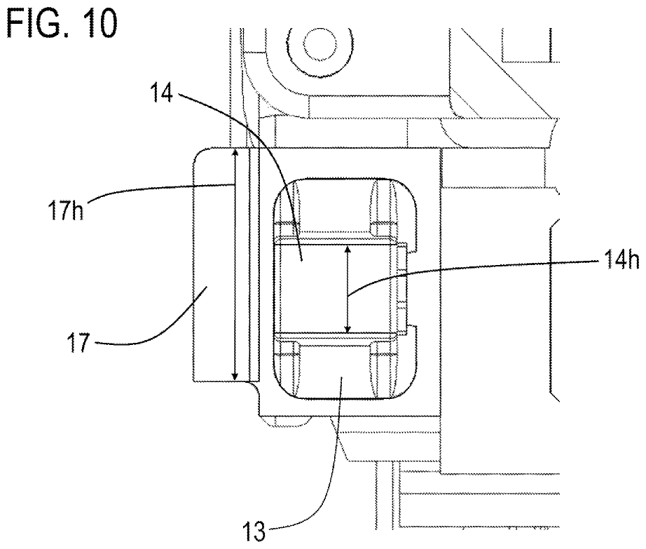

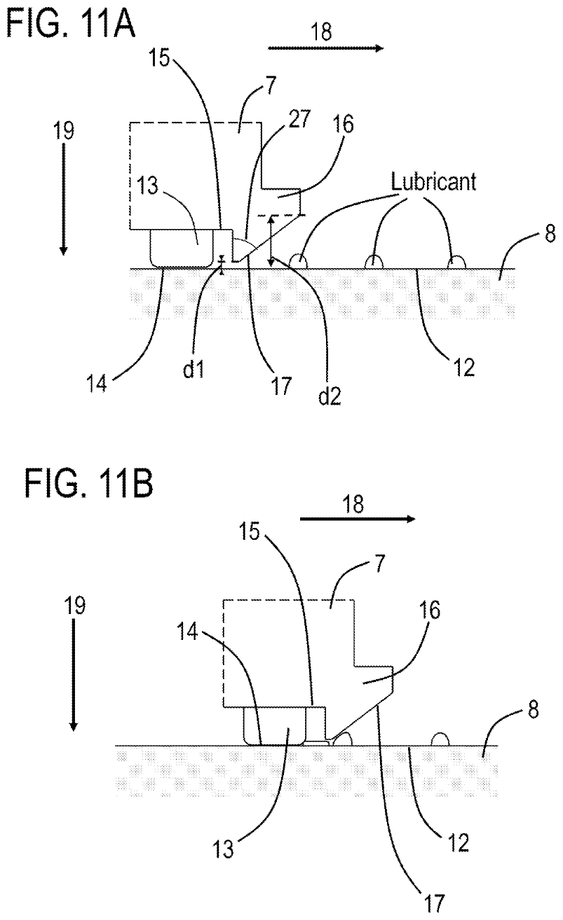

FIG. 9 is a sectional view of the carriage 7 illustrated in FIG. 8, taken along the C-C section. The carriage 7 includes a projecting portion 16 as a cover member that covers a side surface of the sliding member 13, the projecting portion 16 projecting to one side in the direction 18 with respect to the sliding member 13 provided in the carriage 7 and extending from an attachment surface 15 of the sliding member 13 to a location before the sliding surface 14. The projecting portion 16 has an inclined surface 17. The inclined surface 17 is positioned on one side with respect to the sliding surface 14 in the direction 18 as the main scanning direction in which the carriage 7 performs the first scanning after the carriage 7 is assembled to the guide member 8. The inclined surface 17 is inclined such that the distance between the sliding surface 14 and the inclined surface 17 in a direction 19 component that is perpendicular to the direction 18 becomes longer farther away from the sliding member 13 in the direction 18. That is, the projecting portion 16 extends to a location before the sliding surface 14 such that the distance between the sliding surface 14 and the inclined surface 17 becomes shorter toward the sliding member 13 in the direction 18 as the main scanning direction. FIG. 10 is an enlarged view of an area (DTii in FIG. 8) around the sliding member 13. When the lengths of the inclined surface 17 and the sliding surface 14 in a direction 19 that is perpendicular to the ejection surface and that is orthogonal to the direction 18 are defined as a width 17h and a width 14h, respectively, the width 17h is larger than the width 14h. In addition, the width 17h is larger than a width 12h as the sliding range of the guide surface 12, that is, the width 12h of the guide surface 12 in a direction that is orthogonal to the direction 18. FIGS. 11A and 11B are each a schematic view illustrating how a lubricant is spread according to the present embodiment. When the gap between the inclined surface 17 of the projecting portion 16 and the guide surface 12 on the side closer to the sliding member 13 in the direction 18 is defined as a gap d1 and the gap between the inclined surface 17 and the guide surface 12 on the side farther from the sliding member 13 is defined as a gap d2, the relationship d1<d2 is met. That is, when the recording apparatus 1 is assembled and the sliding surface 14 of the sliding member 13 and the guide surface 12 of the guide member 8 face each other as illustrated in FIG. 11A, the projecting portion 16 and the inclined surface 17 are configured such that the gap formed from the guide surface 12 becomes smaller toward the sliding member 13 in the direction 18. The projecting portion 16 is configured to extend to a location before the sliding surface 14 at which the gap discussed earlier is d1 in the direction in which the sliding surface 14 and the guide surface 12 face each other. To spread the lubricant between the guide surface 12 and the sliding surfaces 11 and 14 during product assembly, the lubricant is pushed against the inclined surface 17 and spread by attaching the carriage 7 to the guide member 8 with the lubricant applied to the guide surface 12 and moving the carriage 7 in the direction 18 in the main scanning direction for scanning. That is, the lubricant application method according to the present embodiment includes the following steps. First, the carriage 7 is moved toward one side of the guide member 8 in the direction 18 as the main scanning direction (first moving step). Next, after the first moving step, the lubricant on the guide surface 12 is brought into contact with the inclined surface 17 of the projecting portion 16 as a cover member (contact step). Then, the lubricant in contact with the inclined surface 17 is applied to the sliding surface 14 (application step). After the application step, the carriage 7 is reciprocally moved in the direction opposite to the direction 18 (second moving step). With the lubricant application method including such steps, the inclined surface 17 located on one side with respect to the sliding surface 14 in the direction 18 is brought into contact with the lubricant before the sliding surface 14. Therefore, the lubricant is relatively moved between the sliding surface 14 and the guide surface 12 with the lubricant squeezed by the inclined surface 17 and spread on the guide surface 12, which allows the sliding surface 14 to slide with the guide surface 12 via the lubricant. This enables the lubricant to be efficiently spread on the guide surface 12 without wasting the lubricant adhering to the side surface of the sliding member 13 etc. Regarding the degree of inclination (inclination angle) of the inclined surface 17, studies by the inventors have revealed that a large effect is obtained when an angle 27 in FIG. 11A is 20° or more and less than 90°.

A large effect is obtained when the distance between the guide surface 12 and the inclined surface 17 in the direction 19 is as short as possible, since the lubricant can be spread to be thin. When the inclined surface 17 and the guide surface 12 contact each other, however, the sliding load is increased to increase power consumption. Therefore, it is desirable that the inclined surface 17 and the guide surface 12 should not contact each other in consideration of the component tolerance, the amount of wear of the sliding surface 14, and the inclination caused when the carriage 7 is rotated about an axis that is perpendicular to the ejection surface.

As discussed above, the width 17h of the inclined surface 17 is larger than the width 14h of the sliding surface 14. This enables the lubricant to be spread in the range in which the sliding surface 14 is in contacts with the guide surface 12. When the widths are equivalent to each other, the width 14h is larger than the width 17h when the component tolerance is taken into consideration, and therefore the lubricant may not be spread well over the entire sliding surface 14. In that case, the wear of the sliding surfaces 11 and 14 and the sliding load between the sliding surfaces 11 and 14 and the guide surface 12 may be increased. In addition, the width 17h is larger than the width 12h of the guide surface. When the width 17h is larger than the width 12h, the lubricant on the guide surface 12 can be spread exhaustively to allow grease to be applied to the entire sliding range on the guide surface.

In the present embodiment, the projecting portion 16 with the inclined surface 17 is not provided around the sliding member 23 located at the upper part of the carriage 7. While the projecting portion is preferably provided from the viewpoint of spreading the lubricant, the projecting portion is not provided in the present configuration in order to prevent contact with the hole 20 during assembly to the guide member 8.

### Second Embodiment

A second embodiment of the present invention will be described below with reference to the drawings. The present embodiment is similar in basic configuration to the first embodiment, and therefore only characteristic features will be described below.

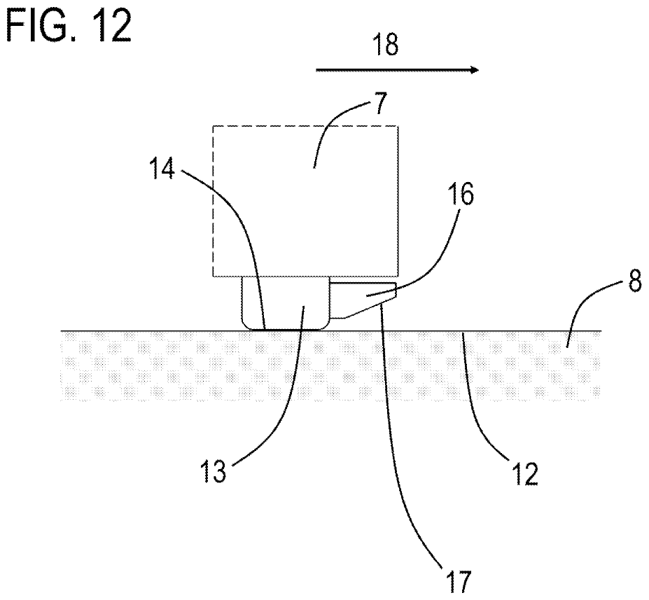

FIG. 12 is a schematic view of an area around a sliding member 13 according to a second embodiment of the present invention. In the present embodiment, a projecting portion 16 (cover member) that has an inclined surface 17 is provided on a side surface of the sliding member 13. That is, the projecting portion 16 as the cover member is configured to cover a side surface of the sliding member 13 by tightly contacting the side surface of the sliding member 13. Also in the present embodiment, as in the first embodiment, the inclined surface 17 is positioned on one side in the direction 18 with respect to the sliding member 13 which has a sliding surface 14. Therefore, also in this embodiment, the inclined surface 17 contacts the lubricant on the guide surface 12 before the sliding surface 14. This allows the lubricant to be applied between the sliding surface 14 and the guide surface 12 in a squeezed state, which enables the lubricant to be efficiently spread on the guide surface 12.

### Third Embodiment

A third embodiment of the present invention will be described below with reference to the drawings. The present embodiment is also similar in basic configuration to the first embodiment, and therefore only characteristic features will be described below.

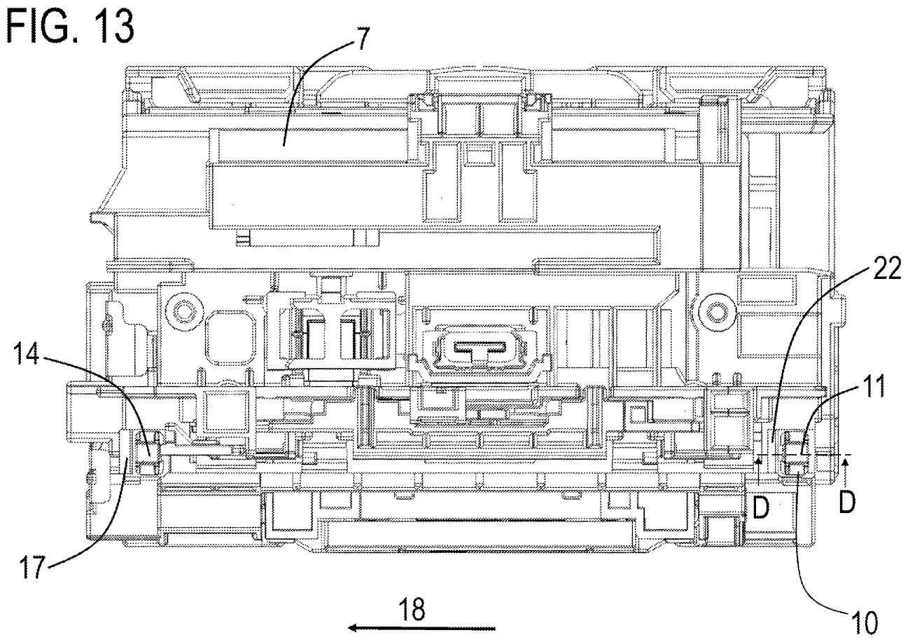

FIG. 13 is a back view of a carriage 7 according to the third embodiment.

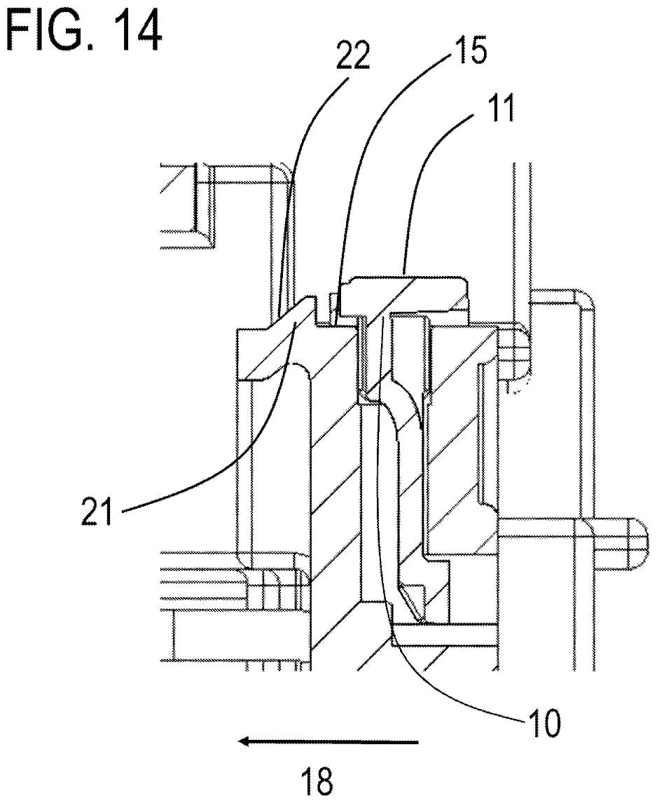

FIG. 14 is a sectional view of an area around a sliding member 10 (taken along the D-D section in FIG. 13). In the present embodiment, besides the sliding member 13 provided at one end portion of the carriage 7 in the direction 18, a projecting portion 21 with an inclined surface 22 is provided around the sliding member 10 provided at the other end portion of the carriage 7, as with the projecting portion 16 provided on the sliding member 13. Regarding the positional relationship, the projecting portion 21 with the inclined surface 22 is provided on one side in the direction 18 with respect to the sliding member 10 (sliding surface 11) and between the sliding member 10 and the sliding member 13 (sliding surface 14). That is, the sliding member 13 provided at one end portion of the carriage 7 in the direction 18 corresponds to a first sliding member, the sliding surface 14 corresponds to a first sliding surface, and the projecting portion 16 on the sliding member 13 side corresponds to a first cover member. In that case, the sliding member 10 corresponding to a second sliding member provided at the other end portion of the carriage 7 in the direction 18 is also provided with the projecting portion 21 having the inclined surface 22 and corresponding to a second cover member that covers a side surface. As with the projecting portion 16 and the inclined surface 17, the projecting portion 21 and the inclined surface 22 are configured such that the gap formed from the guide surface 12 becomes smaller toward the sliding member 10 in the direction 18. The projecting portion 21 extends to a location before the sliding surface 11 in the direction in which the sliding surface 11 and the guide surface 12 face each other.

When the sliding member 10 does not have the inclined surface 22 and only the inclined surface 17 on the sliding member 13 side is provided when the lubricant is to be spread by moving the carriage 7 for scanning during product assembly, the lubricant around the sliding surface 14 can be spread to be thin. However, the lubricant applied onto the guide surface 12 and provided between the sliding surface 11 and the sliding surface 14 is brought into direct contact with the sliding surface 11 without being spread to be thin, and may adhere to a side surface of the sliding member 10. By also providing the sliding member 10 with the projecting portion 21 and the inclined surface 22 as in the present embodiment, the sliding surfaces 11 and 14 can be slid with the guide surface 12 with the lubricant provided between the sliding surface 11 and the sliding surface 14 also spread to be thin. Hence, the lubricant can be spread more efficiently in the third embodiment than in the first embodiment.

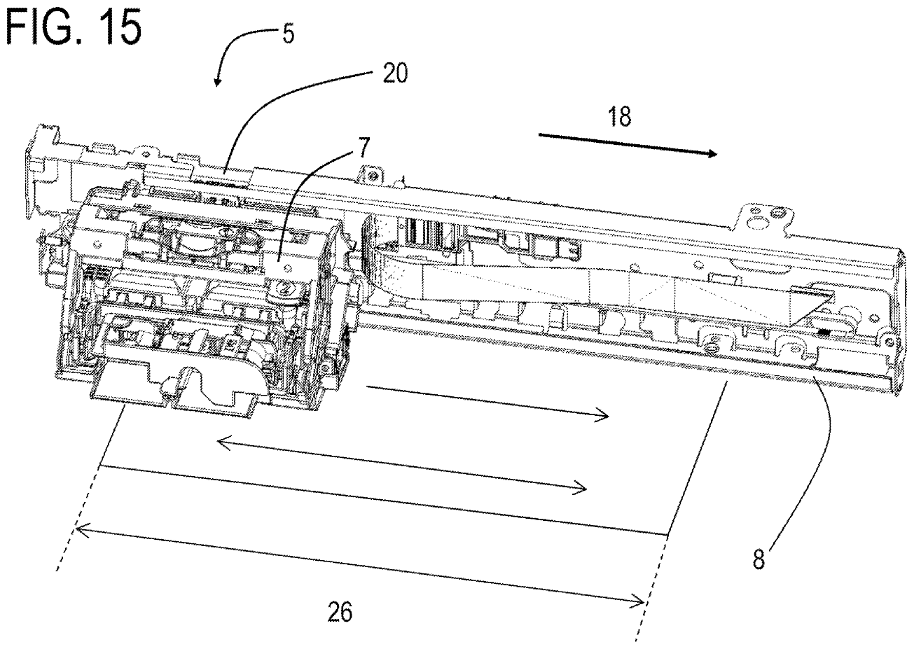

FIG. 15 is a perspective view of a carriage unit 5 according to the third embodiment, illustrating a CR scanning range 26 as the scanning range of the carriage 7. The position of the carriage 7 in FIG. 15 is the position for assembly to the guide member 8. The CR scanning range 26 is located on one side in the direction 18 with respect to the inclined surface 22, and the lubricant is reliably applied onto the guide surface 12 within the CR scanning range 26 after the carriage 7 is assembled to the guide member 8.

### Fourth Embodiment

A fourth embodiment of the present invention will be described below with reference to the drawings. The present embodiment is also similar in basic configuration to the first embodiment, and therefore only characteristic features will be described below.

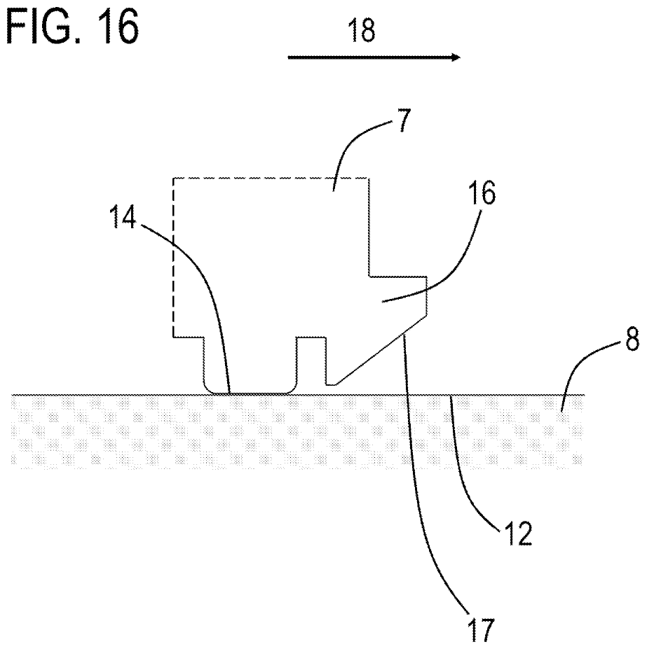

FIG. 16 is a schematic view around a projecting portion 16 as a cover member according to the fourth embodiment. In the present embodiment, a carriage 7 and a sliding member 13 are not separate components, but are formed integrally with each other. When the carriage 7 and the sliding member 13 are formed integrally with each other in this manner, the number of components is reduced to lead to a cost reduction. The positional relationship between a sliding surface 14 and an inclined surface 17 is the same as that according to the first embodiment, and the lubricant can be efficiently spread by the inclined surface 17 in the same manner.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-144041, filed on Sep. 9, 2022, which is hereby incorporated by reference herein in its entirety.

What is claimed is:

1. A recording apparatus comprising:
a carriage on which a liquid ejection head that ejects a liquid is mounted, the carriage being reciprocally movable in a scanning direction;
a guide member that extends in the scanning direction and that guides movement of the carriage in the scanning direction; and
a sliding member that is provided on the carriage and has a sliding surface that slides with a guide surface of the guide member via a lubricant, in a case where the carriage moves in the scanning direction, wherein:
the carriage has a projecting portion that projects farther toward one side in the scanning direction than the sliding member; and
a gap formed between the projecting portion and the guide surface becomes smaller toward the sliding member in the scanning direction.

2. The recording apparatus according to claim 1, wherein
the projecting portion extends to a location before the sliding surface in a direction in which the sliding surface faces the guide surface.

3. The recording apparatus according to claim 1, wherein
the projecting portion has an inclined surface, and
the inclined surface is inclined such that the gap formed between the inclined surface and the guide surface becomes smaller toward the sliding member in the scanning direction.

4. The recording apparatus according to claim 3, wherein
a width of the inclined surface in an orthogonal direction that is orthogonal to the scanning direction is larger than a width of the sliding surface in the orthogonal direction and a width of the guide surface in the orthogonal direction.

5. The recording apparatus according to claim 1, wherein
the projecting portion is provided on a side surface of the sliding member.

6. The recording apparatus according to claim 1, wherein
the sliding member is formed integrally with the carriage.

7. The recording apparatus according to claim 3, wherein
the inclined surface has an inclination angle of 20° or more and less than 90°.

8. The recording apparatus according to claim 1, wherein
the sliding member is provided at one end portion of the carriage in the scanning direction.

9. The recording apparatus according to claim 8, further comprising
a second sliding member that is provided at the other end portion of the carriage in the scanning direction, the second sliding member having a second sliding surface that slides with the guide surface of the guide member via the lubricant, in a case where the carriage moves in the scanning direction, wherein
the carriage has a second projecting portion that projects farther toward the one side in the scanning direction than the second sliding member; and
a gap formed between the second projecting portion and the guide surface becomes smaller toward the second sliding member in the scanning direction.

10. The recording apparatus according to claim 9, wherein
the second projecting portion extends to a location before the second sliding surface.

11. A method of applying a lubricant to the sliding surface of the sliding member of the recording apparatus according to claim 1, the method comprising:
a first moving step of moving the carriage toward one side of the guide member in the scanning direction;
a contact step of bringing the lubricant on the guide surface into contact with the projecting portion, after the first moving step;
an application step of applying the lubricant, which has been brought into contact with the projecting portion, to the sliding surface, after the contact step; and
a second moving step of reciprocally moving the carriage in the scanning direction, after the application step.
